(19) United States
(12) Patent Application Publication
(10) Pub. No.: US 2018/0312083 A1
(43) Pub. Date: Nov. 1, 2018

(54) VEHICLE SEAT-CHANGE ASSIST

(71) Applicant: Ford Global Technologies, LLC, Dearborn, MI (US)

(72) Inventors: Oswaldo Perez Barrera, Texcoco (MX); Alvaro Jimenez Hernandez, Mexico City (MX)

(73) Assignee: Ford Global Technologies, LLC, Dearborn, MI (US)

(21) Appl. No.: 15/498,826

(22) Filed: Apr. 27, 2017

(51) Int. Cl. B60N 2/02; B60R 22/48

(52) U.S. Cl. CPC B60N 2/0244; B60R 22/48

(57) ABSTRACT

A system includes a computer programmed to receive data describing one or more vehicle operations from one or more vehicle input device. The computer actuates an output device upon determining, based on the received data, that a seat-change condition is met.

### BACKGROUND

Occupants of a vehicle may desire to change from one seat of the vehicle to another seat of the vehicle while the vehicle is in motion. However, such occupants may be unable to determine whether such seat-change is possible, practical, and/or prudent.

### BRIEF DESCRIPTION OF THE DRAWINGS

FIG. 1 is block diagram of an example system for a seat-change assist.

FIG. 2 is a perspective view of a passenger cabin of an example vehicle.

FIG. 3 is an illustration of the example vehicle a distance from other vehicles.

FIG. 4 is an illustration of the example vehicle following a route.

FIG. 5 is a flow chart for an example process of performing a seat-change assist.

### DETAILED DESCRIPTION

### Introduction

Disclosed herein is a method comprising receiving data describing one or more vehicle operations from one or more vehicle input device, and actuating an output device upon determining, based on the received data, that a seat-change condition is met.

The method may further include determining that the seat-change condition is met is based on a route of the vehicle.

The method may further include determining that the seat-change condition is met includes a determination that the seat-change condition is predicted to continue to be met for a threshold amount of time.

The threshold amount of time is based on a first seat location and a second seat location.

The method may further include determining that the seat-change condition is met includes a determination that a speed of the vehicle is below a threshold.

The method may further include reducing a speed of the vehicle upon determining that the seat-change condition is predicted to be met for less than a threshold amount of time.

The method may further include actuating a vehicle restraint system to an unlocked state upon the determining that the seat-change condition is met.

The method may further include determining that the seat-change condition is met includes a determination that no other vehicles are within a threshold distance of the vehicle.

The method may further include determining that the seat-change condition is met includes a determination that the vehicle is predicted to not accelerate above a threshold amount within a threshold time.

The method may further include determining that the seat-change condition is met is based on a location of the vehicle.

Also disclosed herein is a computer programmed to perform the disclosed method.

Also disclosed herein is a computer readable medium storing program instructions executable by a computer processor to perform the disclosed method.

Also disclosed here in a system, comprising a computer programmed to receive data describing one or more vehicle operations from one or more vehicle input device, and to actuate an output device upon determining, based on the received data, that a seat-change condition is met.

The computer may further be programmed to determine that the seat-change condition is met based on a route of the vehicle.

The computer may further be programmed to determine that the seat-change condition is met based on a determination that the seat-change condition is predicted to continue to be met for a threshold amount of time.

The computer may further be programmed to identify the threshold amount of time based on a first seat location and a second seat location.

The computer may further be programmed to determine that the seat-change condition is met based on a determination that a speed of the vehicle is below a threshold.

The computer may further be further programmed to reduce a speed of the vehicle upon determining that the seat-change condition is predicted to be met for less than a threshold amount of time.

The computer may further be programmed to actuate a vehicle restraint system to an unlocked state upon the determining that the seat-change condition is met.

The computer may further be programmed to determine that the seat-change condition is met based on a determination that no other vehicles are within a threshold distance of the vehicle.

The computer may further be programmed to determine that the seat-change condition is met based on a determination that the vehicle is predicted to not accelerate above a threshold amount within a threshold time.

The computer may further be programmed to determine that the seat-change condition is met based on a location of the vehicle.

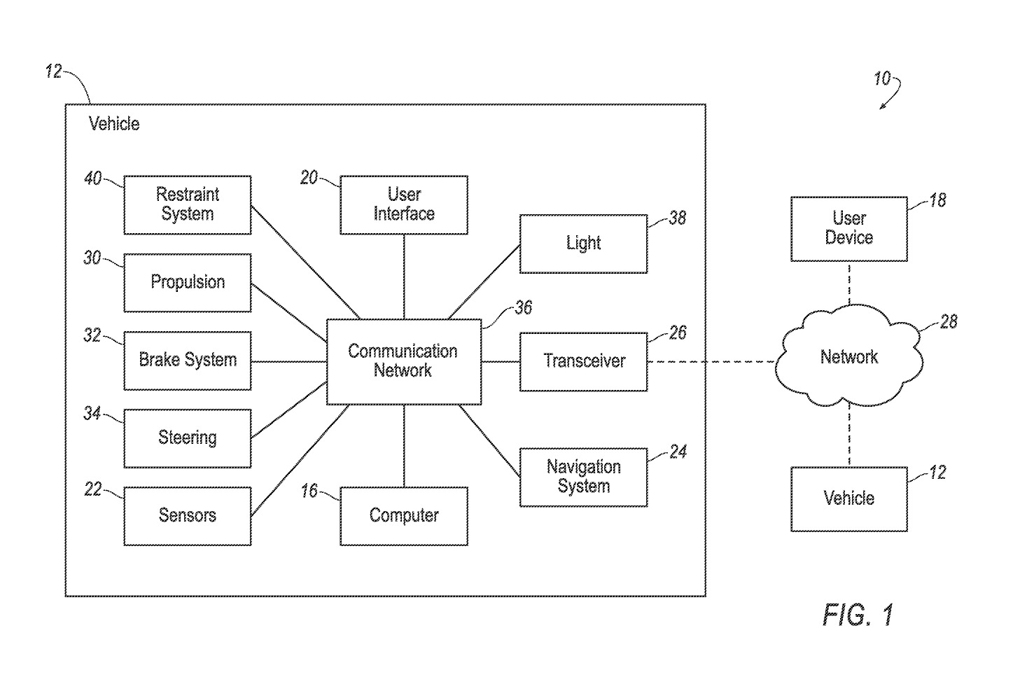

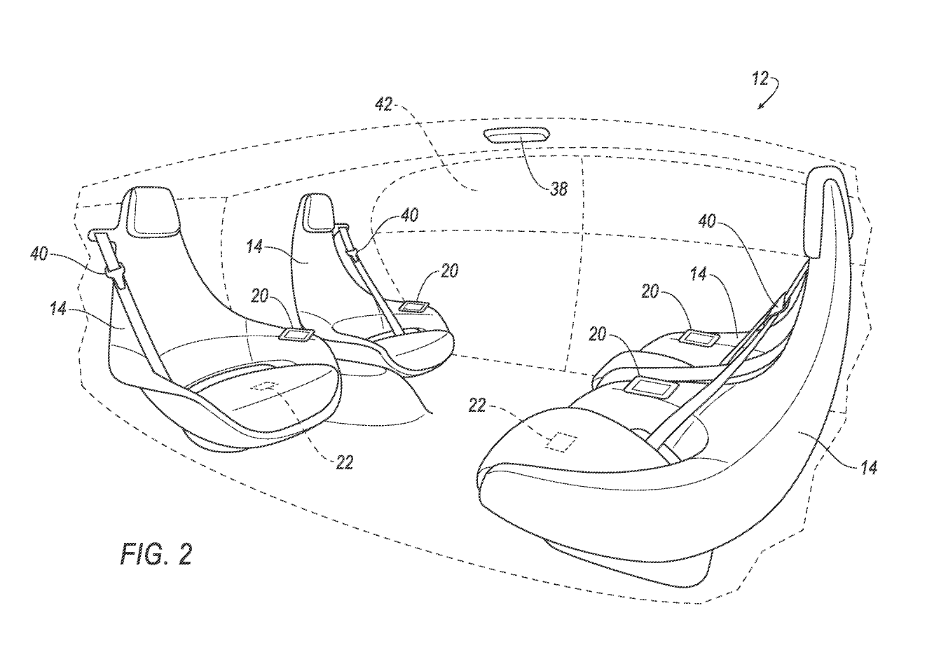

With reference to FIGS. 1 and 2, wherein like numerals indicate like parts throughout the several views, a system 10 for assisting occupants of a vehicle 12 to change from one seat 14 of the vehicle 12 to another includes a computer 16 programmed to receive data describing one or more vehicle operations from one or more vehicle 12 input device. The computer 16 is programmed to actuate an output device upon determining, based on the received data, that a seat-change condition is met. The seat-change may be requested by an occupant of the vehicle 12, e.g., with a user device 18 and/or with a user interface 20 of the vehicle 12.

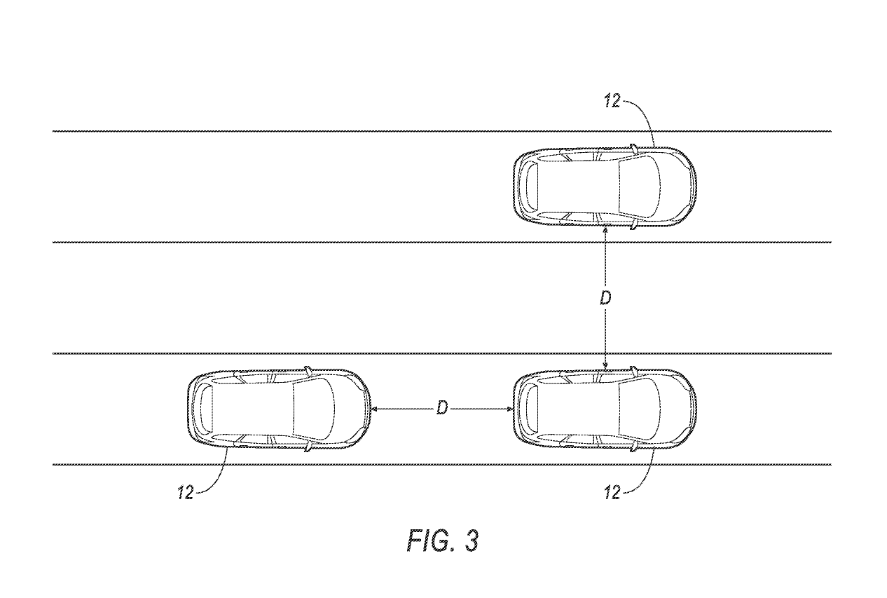

As used herein, data describing vehicle operations include data describing a present and/or predicted state of the vehicle 12, e.g., a speed of the vehicle 12, an acceleration of the vehicle 12, etc. Additionally or alternatively, data describing vehicle operations can include data describing the present and/or predicated surrounding environment of the vehicle 12, e.g., a distance D to another vehicle 12 (shown in FIG. 3), a location of the vehicle 12, etc.

As used herein, a vehicle 12 input device is an electronic device that provides information to the computer 16. Example vehicle input devices include the vehicle sensors 22, navigation system 24, transceiver 26, etc.

As used herein, an output device is an electrical or electromechanical device in communication with the computer 16 that can provide an indication to the occupant of the vehicle 12 identifying whether one or more seat-change condition is met. Example output devices include a vehicle 12 user interface 20, a light 38 supported within the vehicle 12, a user device 18, etc.

As used herein, a seat-change condition is a rule describing a present and/or predicted future state of the vehicle 12, and/or surrounding environment, that, when met, indicates that the seat-change by the occupant may be safe, and when unmet, indicates that the seat-change by the occupant may be unsafe.

### System

The user device 18 may be any one of a variety of computing devices including a processor and a memory, and implemented via circuits, chips, antenna, or other electronic components, e.g., a smartphone, a tablet, a personal digital assistant, etc. The user device 18 includes a user interface that presents information to and receives information from a user of the user device 18. The user interface may include a touch-sensitive display screen, speaker, microphone, etc. The user device 18 may communicate with the vehicle computer 16 e.g., via radio frequency (RF) communications, via a network 28, etc.

The network 28 (sometimes referred to as a wide area network because it can include communications between devices that are geographically remote from one another, i.e., not in a same building, vehicle, etc.,) represents one or more mechanisms by which the remote devices may communicate with each other, e.g., the vehicle 12 communicating with the user device 18, etc. Accordingly, the network 28 may be one or more wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, IEEE 802.11, etc.), local area networks (LAN) and/or wide area networks (WAN), including the Internet, providing data communication services.

The vehicle 12, sometimes referred to herein as the host vehicle 12, may include any semi-autonomous or autonomous passenger or commercial automobile such as a sedan, a station wagon, a sport utility vehicle, a crossover vehicle, a van, a minivan, a taxi, a bus, etc. A computer 16, sometimes referred to as the vehicle 12 controller 16, may be capable of operating the vehicle 12 independently of the intervention of a human driver, completely or to a greater or a lesser degree. The computer 16 may be programmed to operate a propulsion 30, a brake system 32, a steering 34, and/or other vehicle systems.

For purposes of this disclosure, an autonomous mode is defined as one in which the propulsion 30, the brake system 32, and the steering 34 of the vehicle 12 are controlled by one or more computers 16; in a semi-autonomous mode computer(s) 16 of the vehicle 12 control(s) one or two of vehicle the propulsion 30, the brake system 32, and the steering 34.

As seen in FIG. 1, a block diagram illustrates the system 10 for assisting occupants of a vehicle 12 to change from one seat 14 of the vehicle 12 to another, along with elements in the vehicle 12, such as a communication network 36 that provides communication between other vehicle 12 components such as the propulsion 30, the brake system 32, the steering 34, the navigation system 24, a user interface 20, an interior light 38, a restraint system 40, sensors 22, the transceiver 26, and the computer 16.

As seen in FIG. 2, the vehicle 12 includes a passenger cabin 42 to house occupants, if any, of the vehicle 12. The passenger cabin 42 includes a first and second row of seats 14. The passenger cabin 42 may also include a third row of seats (not shown), and/or other additional seats and/or seat arrangements. The position and orientation of the seats 14, and components thereof, may be adjustable by an occupant. In FIG. 2, the seat 14 is shown to be a bucket seat, but the seats 14 may be included in other seat types, e.g., a bench seat. A seat 14 is defined for purposes of this disclosure as a vehicle seat or portion thereof designed or intended to hold one individual occupant. A bench seat or other type of seat designed for more than one occupant can include multiple portions that each can hold an individual occupant, e.g., a first portion for holding a first individual occupant and a second portion for holding a second individual occupant. Such seat designed or intended for more than one occupant includes, therefore, in the context of this disclosure, two or more seats 14, i.e., two or more seating portions each for an individual occupant.

The vehicle 12 communication network 36 includes hardware, such as a communication bus, for facilitating communication among vehicle 12 components. The communication network 36 may facilitate wired or wireless communication among the vehicle components in accordance with one or more communication protocols such as controller area network (CAN), Ethernet, WiFi, Local Interconnect Network (LIN), and/or other wired or wireless mechanisms.

The propulsion 30 of the vehicle 12 generates kinetic energy, e.g., torque to provide a rotational motion, and translates the energy into motion of the vehicle. The propulsion 30 may be a known vehicle propulsion subsystem, for example, a conventional powertrain including an internal-combustion engine coupled to a transmission that transfers rotational motion to wheels; an electric powertrain including batteries, an electric motor, and a transmission that transfers rotational motion to the wheels; a hybrid powertrain including elements of the conventional powertrain and the electric powertrain; or any other type of propulsion 30. The propulsion 30 is in communication with and receives input from the computer 16 and/or from a human driver. The human driver may control the propulsion 30 via, e.g., an accelerator pedal and/or a gear-shift lever.

The brake system 32 resists the motion of the vehicle 12 to thereby slow and/or stop the vehicle 12, e.g., known vehicle braking subsystems. The brake system 32 may be friction brakes such as disc brakes, drum brakes, band brakes, etc.; regenerative brakes; any other suitable type of brakes; or a combination thereof. The brake system 32 can include an electronic control unit (ECU) or the like that actuates the brake system 32 to resist the motion of the vehicle 12, e.g., in response to a command from the computer 16 and/or from a human driver. The human driver may control the brake system 32 via, e.g., a brake pedal.

The steering 34 is typically a known vehicle steering subsystem and controls the turning of the wheels. The steering 34 is in communication with and receives input from a steering wheel and/or the computer 16. The steering 34 may be a rack-and-pinion system with electric power-assisted steering, a steer-by-wire system, as are both known in the art, or any other suitable system.

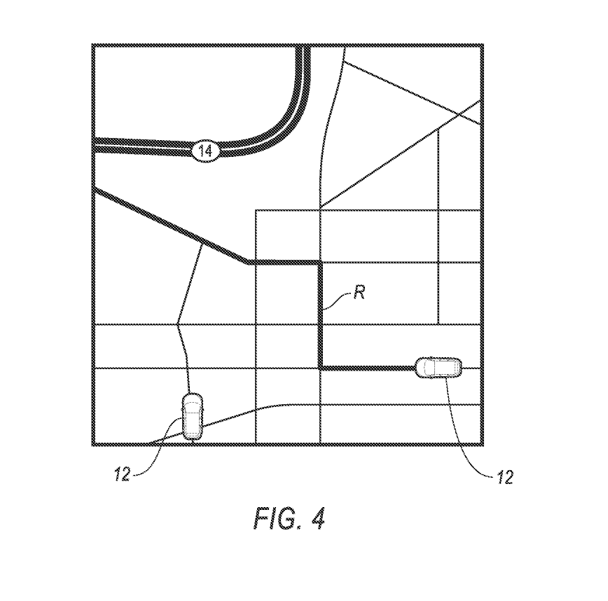

The navigation system 24 is implemented via circuits, chips, or other electronic components that can determine a present location of the vehicle 12. The navigation system 24 may be implemented via satellite-based system such as a Global Positioning System (GPS). The navigation system 24 may triangulate the location of the vehicle 12 based on signals received from various satellites in the Earth's orbit. The navigation system 24 is programmed to output signals representing the present location of the host vehicle 12 to, e.g., the processor via the communication network 36. In some instances, the navigation system 24 is programmed to determine a route R from the present location to a future location (shown in FIG. 4). The navigation system 24 may access map data stored in the memory (discussed below) and develop the route R according to the map data. The map data may include speed limits, intersection information, e.g., locations of stop signs and traffic signals at intersections, turn and curve information, e.g., a radius of a turn at an intersection or curve of a section of a road, etc.

The user interface 20 presents information to and receives information from an occupant of the vehicle 12. The user interface 20 may be located on a surface in the passenger cabin 42 of the vehicle 12, or wherever may be readily seen by the occupant. Multiple user interfaces 20 may be located within the passenger cabin 42, e.g., one user interface 20 proximate each seat 14. The user interface 20 may include dials, digital readouts, screens such as a touch-sensitive display screen, speakers, and so on for providing information to the occupant, e.g., human-machine interface (HMI) elements. The user interface 20 may include buttons, knobs, keypads, microphone, and so on for receiving information from the occupant.

The light 38 converts electricity into visible light. The light 38 includes a light producing structure, such as a tungsten filament, a light emitting diode (LED), etc. The light producing structure may be enclosed, e.g., within a housing including a reflector and lens. The light 38 may be configured to produce a certain spectrum of color, e.g., by including a colored tinted lens. The light 38 may, be configured to produce varying spectrums of color, e.g., by including multiple light, producing structures with different color lens, e.g., a red, blue and green LED. The light 38 may include various circuits, chips, wiring, or other electronic components to provide control of a brightness and or color of the light 38, e.g., in response to a command received via the communication network 36, and/or a change in power supplied to the light 38, e.g., a change in voltage. Example lights 38 include vehicle 12 cabin dome lights, foot well lights, etc.

The restraint system 40 restrains an occupant of a vehicle 12 seat 14 within such seat 14. The restraint system 40 may be a three-point harness, meaning that webbing is attached at three points around the occupant when fastened, e.g., with a lap-belt mounting anchor, a retractor, and a buckle received in a latch. The restraint system 40 may, alternatively, include other arrangements of attachment points. The restraint system 40 may include various circuits, chips, wiring, actuators, or other electronic components to control the restraint system 40 to actuate between a locked state and an unlocked state. In the locked state the restraint system 40 is inhibited from releasing the occupant, e.g., by inhibiting removal of the buckle from the latch. In the unlocked state the restraint system 40 is permitted to release the occupant, e.g., by permitting removal of the buckle from the latch.

The sensors 22 may detect internal states of the vehicle 12, for example, wheel speed, wheel orientation, and engine and transmission variables. The sensors 22 may detect the position or orientation of the vehicle 12, for example, global positioning system (GPS) sensors; accelerometers such as piezo-electric or microelectromechanical systems (MEMS) sensors; gyroscopes such as rate, ring laser, or fiber-optic gyroscopes; inertial measurements units (IMU); and magnetometers. The sensors 22 may detect the external world and/or passenger cabin, for example, proximately sensors, weight sensors, radar sensors, scanning laser range finders, light detection and ranging (LIDAR) devices, and image processing sensors such as cameras. The sensors 22 may include communications devices, for example, vehicle-to-infrastructure (V2I) or vehicle-to-vehicle (V2V) devices.

The transceiver 26 transmits and receives information wirelessly from other transceivers, either directly or via the network 28, enabling signals, data and other information to be exchanged with other computers and network systems, e.g., the user device 18. The transceiver 26 is implemented via antennas, circuits, chips, or other electronic components that can facilitate wireless communication. Example transceivers 26 include Wi-Fi systems, radio transmitters and receivers, telecommunications systems, Bluetooth® systems, cellular systems and mobile satellite transceivers.

The vehicle computer 16, implemented via circuits, chips, or other electronic components, is included in the vehicle 12 for carrying out various operations, including as described herein. The vehicle computer 16 is a computing device that generally includes a processor and a memory, the memory including one or more forms of computer-readable media, and storing instructions executable by the processor for performing various operations, including as disclosed herein.

The memory of the vehicle computer 16 generally stores remote data received via various communications mechanisms; e.g., the vehicle computer 16 is generally configured for communications on a controller area network (CAN) bus or the like, and/or for using other wired or wireless protocols, e.g., Bluetooth, etc. Via the communication network 36 using Ethernet, WiFi, the CAN bus, Local Interconnect Network (LIN), and/or other wired or wireless mechanisms, the vehicle computer 16 may transmit messages to various devices in the vehicle 12 and/or receive messages from the various devices, e.g., controllers, actuators, sensors, etc., e.g., controllers and sensors as discussed herein. For example, the vehicle computer 16 may receive data from vehicle sensors 22. The memory of the computer 16 may store various lookup tables or the like, including those discussed herein.

The computer 16 may be programmed to determine whether various seats 14 of the vehicle 12 are occupied, e.g., based on information received from weight and/or proximity sensors 22 supported by the seats 14 of the vehicle 12 to detect the presence of an occupant in a certain seat 14, etc.

The computer 16 may receive a seat-change request. For purposes of this disclosure, a seat-change request is an input from an occupant of the vehicle 12 specifying that an occupant desires to switch from a first seat 14 of the vehicle 12 to a second seat 14 of the vehicle 12. The seat-change request may include a current seat 14, i.e., a seat 14 of the occupant at a time the seat-change is requested, and a desired seat 14. The seat-change request may be provided via the user device 18, e.g., as a message from the user device 18 to the vehicle 12 based on an occupant input to user device 18, and/or with the user interface 20 of the vehicle 12, e.g., based on an occupant input to the user interface 20.

The computer 16 may store and/or determine a threshold amount of seat-change time, i.e., an amount of time allowed for an occupant to change from a first seat 14 to a second seat 14.

The threshold amount of seat-change time may be a fixed amount stored in the memory of the computer 16 by the manufacturer of the vehicle 12. The fixed threshold amount of seat-change time may be determined based on empirical testing, e.g., an average amount of time it takes a vehicle 12 occupant to change from a first seat 14 to a second seat 14 of the vehicle 12. The average amount of time may be multiplied by a safety factor, e.g., a factor of two, to determine the threshold amount of seat-change time.

Additionally or alternatively, the threshold amount of seat-change time may be determined by the computer 16 based on a current seat 14 and a desired seat 14 of an occupant of the vehicle 12. For example, the computer 16 may store a seat-change time lookup table correlating various threshold amounts of seat-change time with various seat-change combinations. In such lookup table, different seat-change combinations may be correlated with different times based on their relative locations, orientations, etc., e.g. seats 14 that are closer will have a lower threshold amount of seat-change time than seats 14 that are farther away, seats 14 that are facing each other will have a lower threshold amount of seat-change time than seats 14 that do not face each other, etc. The lookup table may be determined by a manufacturer of the vehicle 12, e.g., based on empirical testing of how long it takes an occupant to change from a specific seat 14 to in the vehicle 12 to another specific seat 14. The times in the lookup table may be determined with a safety factor, as discussed above. An example seat-change time lookup table is shown below:

| | | Threshold |
|---|---|---|
| | | Amount of |
| | | Seat-Change |
| Current Seat | Desired Seat | Time |
| 1^{st} Row 1^{st} Side of Vehicle | 1^{st} Row 2^{nd} Side of Vehicle | 30 Seconds |
| 1^{st} Row 1^{st} Side of Vehicle | 2^{nd} Row 2^{nd} Side of Vehicle | 40 Seconds |
| 1^{st} Row 1^{st} Side of Vehicle | 2^{nd} Row 1^{st} Side of Vehicle | 20 Seconds |
| 2^{nd} Row 1^{st} Side of Vehicle | 2^{nd} Row 2^{nd} Side of Vehicle | 30 Seconds |
| 2^{nd} Row 1^{st} Side of Vehicle | 1^{st} Row 1^{st} Side of Vehicle | 20 Seconds |
| 2^{nd} Row 1^{st} Side of Vehicle | 1^{st} Row 2^{nd} Side of Vehicle | 40 Seconds |

The computer 16 may identify the current seat 14 and the desired seat 14 based on the seat-change request, e.g., based on the current seat 14 and the desired seat 14 included in the seat-change request. Alternatively, the current and/or desired seat 14 may be based on information from weight sensors 22 in the various seats 14, and/or based on a location of the user interface 20 relative to the various seats 14 of the vehicle 12. For example, the current seat 14 may be a seat 14 closest to the user interface 20, the current seat 14 may be a seat 14 indicated as occupied with the weight sensors 22, the desired seat may be a seat 14 indicated as unoccupied with the weight sensors 22, etc.

The computer 16 may store a set of seat-change condition rules, e.g., as a seat-change condition rule table in the memory of the computer. The set of seat-change condition rules includes one or more rules that, when met, alone and/or in combination, indicate that a seat-change by an occupant of the vehicle 12 may be safe. The rule many include one or more defined states of the vehicle 12 and/or surrounding environment and an indication of whether such must be met for the threshold amount of seat-change time. An example seat-change condition rule table is shown below:

| | Rule Must Be Met for |
|---|---|
| | Threshold Amount of |
| Rule | Seat-Change Time |
| Acceleration below 1 meter/second² | Yes |
| Speed below speed limit of current road | Yes |
| Speed below 10 miles/hour | No |
| Vehicle at authorized location | No |
| Other vehicle within 40 meters | Yes |
| Other vehicle within 200 meters | No |

Certain example seat-change condition rules are discussed in the following paragraphs, but these examples are not limiting; other rules are possible.

A seat-change condition rule may exist wherein the seat-change condition is based on a determination that no other vehicles 12 are within a threshold distance D of the host vehicle 12. The threshold distance D may be specified for a specific direction relative to an orientation of the host vehicle 12, e.g., in front, behind, etc. The threshold distance D may be a fixed amount, e.g., 100 yards. The threshold distance D may further be relative to a speed of the vehicle 12, e.g., identified based on a lookup table or the like correlating various speeds with various distances, e.g., where higher speeds are correlated with higher threshold distances D. The threshold distance D may be based on the threshold amount of seat-change time discussed above, e.g., identified based on a lookup table or the like correlating various threshold amounts of seat-change time with various distances D, e.g., where higher threshold amounts of time are correlated with higher threshold distances D.

A seat-change condition rule may exist wherein the seat-change condition is based on a geographic location of the vehicle 12. The location may be determined according to geo-coordinates such as are known, e.g., by a navigation system 24 using the Global Positions System (GPS), and/or by proximity to various landmarks that may be indicated in the map data, e.g., municipal and state government districts, schools, interstate highways, etc. For example, the computer 16 memory may store an authorized-location lookup table or the like with an indication of whether a seat-change is authorized or permitted at each of a set of various respective locations, e.g., specified by a range of geo-coordinates, a distance from a set of geo-coordinates, etc. Whether each of the various locations are authorized may be determined based on local law, e.g., a municipal or state law that forbids or permits seat-change. The authorized-location indication may be based on characteristics of a location, e.g., in a heavily traveled urban or suburban area a seat-change may be prohibited, but permitted in a sparsely traveled rural area, etc. The authorized-location indication may be based on the type of road associated with the location, e.g., a smooth paved road, a gravel road with frequent and unpredictable bumps, etc. The type of road associated with the location may be stored in a further lookup table or the like, included in the map data, etc.

A seat-change condition rule may exist wherein the seat-change condition is based on characteristics of a route or portion thereof of the vehicle 12, e.g., a current road the vehicle is traveling on and/or anticipated future roads the vehicle 12 will travel on to reach a desired destination. For example, the rule may specify characteristics that may be obtained from map data for the route, e.g., speed limits, intersection information, turn, and curve information. These characteristics can in turn be associated, e.g., in a further lookup table or the like, with a no-seat change condition (e.g., speed limit above 30 miles per hour, number of turns per mile above a threshold, etc.) or a seat-change-permitted condition (e.g., speed limit above 30 miles per hour, no turns for the next mile, etc.).

A seat-change condition rule may exist that the seat-change condition is based on a determination that the vehicle 12 acceleration is not above a threshold amount, e.g., 1 meter per second per second. As used herein, “acceleration” means a change in velocity of the vehicle 12, e.g. a change in speed and/or a change in direction.

A seat-change condition rule may exist that the seat-change condition is based on a determination that a speed of the vehicle 12 is below a threshold, e.g., 25 miles per hour. The speed threshold may be a fixed amount, e.g., stored in the memory by a manufacturer of the vehicle 12. The speed threshold may be based on a speed limit of a road the vehicle 12 is traveling, e.g., as included in map data.

A seat-change condition rule may exist that the seat-change condition is based on a determination that the seat-change condition is predicted to continue to be met for the threshold amount of seat-change time, e.g., 15 seconds.

The computer 16 may identify a present, and/or predict a future, state of the vehicle 12, and/or surrounding environment, based on information received from the sensors 22. For example, proximity, radar, LIDAR, etc., sensors 22 may indicate that there are no objects, e.g., other vehicles 12, proximate, i.e. within a threshold distance D, e.g., 20 meters, of the host vehicle 12. The distances to the detected objects may be measured at timed intervals, e.g., every 50 milliseconds, and analyzed to determine motion of the detected objects relative to the vehicle 12, e.g., to determine whether the objects are approaching or retreating from the vehicle 12, e.g., to predict future distances between the objects and vehicle 12. As another example, wheel speed sensors 22 may indicate a speed and/or acceleration of the vehicle 12.

The computer 16 may identify a present, and/or predict a future, state of the vehicle 12, and/or surrounding environment, based on information received from the navigation system 24. For example, the navigation system 24 may provide a present location and/or predicted future location of the vehicle 12, e.g., based on the route R and map data, and may provide information for predicting states of the vehicle 12, e.g., acceleration, speed, etc., e.g., based on map data indicating speed limits, stops, turns, curves, etc., along the route R.

The computer 16 may identify a present, and/or predict a future, state of the vehicle 12, and/or surrounding environment, based on information received from the transceiver 26. For example, the computer 16 may use the transceiver 26 to communicate with other vehicles 12 to identify a location, route R, speed, etc. of such vehicles 12. The information from the other vehicles 12 may be used by the computer 16 to predict the proximity of the other vehicles 12 to the host vehicle 12 at various times in the future. For example, the computer 16 may compare the received location, route R, speed, etc., of one or more other vehicles 12 with that of the host vehicle 12.

The computer 16 may be programmed to determine that a present state of the vehicle 12, and/or surrounding environment, meets a seat-change condition. To make such determination, the computer 16 may compare the received data describing the present state of the vehicle 12 and/or surrounding environment, e.g., the present acceleration, speed, location, object proximity, etc., with the various rules in the seat-change condition rule table.

The computer 16 may be programmed to determine that a predicted future state of the vehicle 12, and/or surrounding environment, meets a seat-change condition. To make such determination, the computer 16 may compare the predicted future state of the vehicle 12 and/or surrounding environment, e.g., the predicted acceleration, speed, location, object proximity, etc., with corresponding values included in various rules in the seat-change condition rule table. The predicted future state of the vehicle 12, and/or surrounding environment, compared to one or more values in a rule (e.g., for speed, acceleration, etc.) may be for a specific future time and may be provided periodically, e.g., every 500 milliseconds up to the threshold amount of seat-change time into the future.

For example, the computer 16 may determine that the seat-change condition is met when the rule requiring the vehicle 12 acceleration to remain below an acceleration threshold for a threshold amount of seat-change time. To determine whether such rule is met, the computer 16 may analyze a route R of the vehicle 12, e.g., based on information from the navigation system 24, to identify locations along the route R where the acceleration of the vehicle 12 is anticipated to go above the threshold, e.g., stops at intersections, curves in a road the vehicle 12 is, or will, travel along, etc. The computer 16 may determine an amount of time it will take the vehicle 12 to reach a location closest to the vehicle 12 of the locations along the route R where the acceleration of the vehicle 12 is anticipated to go above the threshold along the route R, e.g., based a current speed of the vehicle 12, the speed limit of the road(s) along the route R, etc. The amount of time it will take the vehicle 12 to reach the closest location where the acceleration of the vehicle 12 is anticipated to go above the threshold may be compared to the threshold amount of seat-change time.

The computer 16 may be programmed to reduce the speed of the vehicle 12 upon determining that the seat-change condition is predicted to be met for less than the threshold amount of seat-change time. For example, when the computer 16 identifies that a curve or intersection is approaching that will raise acceleration above the threshold amount, e.g., by turning or stopping the vehicle 12, before the threshold amount of seat-change time, the computer 16 may slow the vehicle 12 to increase the amount of time it takes for the vehicle 12 to reach the curve or intersection. The vehicle 12 may be slowed such that the amount of time it takes to reach the curve or intersection becomes greater than the threshold amount of seat-change time. The computer 16 may slow the vehicle 12, e.g., by actuating the propulsion 30 to produce less torque and/or by actuating the brake system 32 to resist the motion of the vehicle 12.

The computer 16 may be programmed to actuate an output device, such as the light 38, the user interface 20, the restraint system 40, etc., e.g., by transmitting an instruction to the output device via the communication network 36. The computer 16 may actuate the output device upon determining, based on the received data, that one or more seat-change conditions are met.

The computer 16 may actuate the light 38 to provide a specific color, e.g., green, upon determining that one or more seat-change conditions are met. The computer 16 may then actuate the light 38 provide a different color, e.g., yellow, and/or indication type, e.g., steady state vs. flashing, upon determination that a predetermined amount of time, e.g., 15 seconds, 75% of the threshold time, etc., has lapsed since actuating the light 38 indicating the condition as met. The computer 16 may actuate the light to provide a different color, e.g., red, upon determination that on or more of the seat-change conditions are met.

The computer 16 may actuate the user interface 20, e.g., based on the determinations discussed herein for the light 38, to provide various audible, e.g., tones, recorded voice information, etc., and/or visual, e.g., a text, icon, image, etc., indications.

The computer 16 may be programmed to actuate the restraint system 40 to an unlocked state upon the determining that one or more seat-change conditions are met. For example, upon determining that one or more rules are met, the computer 16 may transmit an instruction to the restraint system 40 to actuate to the unlocked state, e.g. via the communication network 36.

### Process

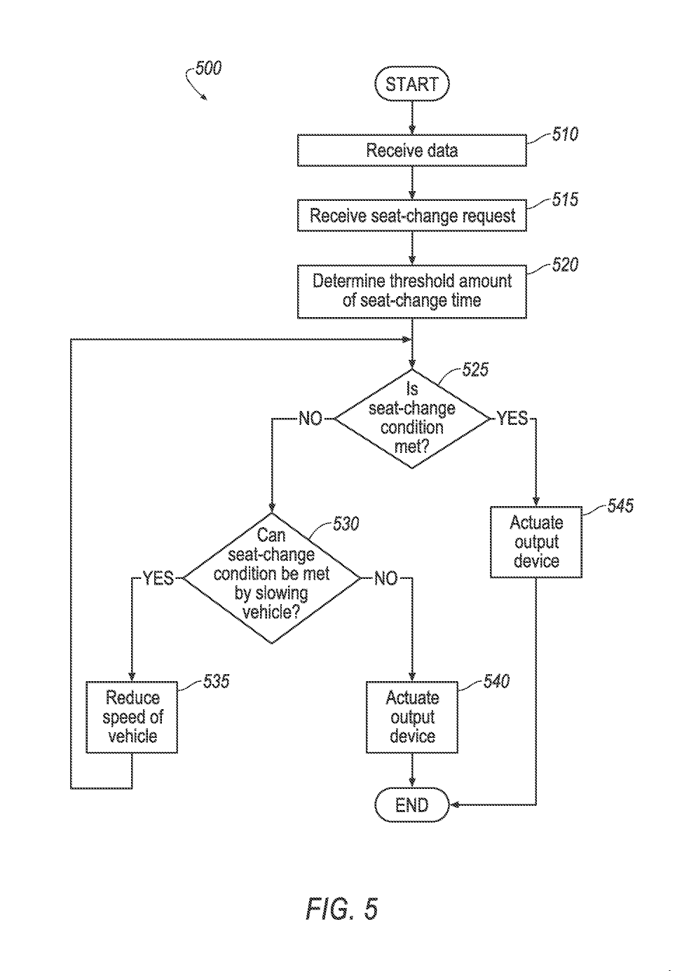

FIG. 5 is a process flow diagram illustrating an exemplary process 500 for assisting occupants of a vehicle 12 to change from a first seat 14 of the vehicle 12 to a second seat 14 of the vehicle 12. The process 500 begins in a block 510 when the vehicle 12 is turned on, e.g., a powertrain such as including an internal combustion engine and/or electric motor is activated, e.g., ignition of the internal combustion engine is accomplished.

At the block 510 the computer 16 receives data describing one or more vehicle operations from one or more vehicle input devices, e.g., from the sensors 22, navigation system 24, and/or transceiver 26. The computer 16 may further receive such data throughout the process 500.

Next, at a block 515 the computer 16 receives a seat-change request, e.g., based on a user input to the user interface 20, the user device 18, etc.

Next, at a block 520 the computer 16 determines the threshold amount of seat-change time, as described above.

Next, at a block 525 the computer 16 determines whether one or more seat-change conditions are met based on the received data describing the one or more vehicle operations. Upon a determination that no seat-change condition is met, the process 500 moves to a block 530. Upon a determination that one or more seat-change conditions are met, the process 500 moves to a block 545.

At the block 530 the computer 16 determines whether one or more seat-change conditions can be met by slowing the vehicle 12. Upon a determination that one or more seat-change conditions can be met by slowing the vehicle 12 the process moves to a block 535. Upon a determination that no seat-change condition can be met by slowing the vehicle 12 the process moves to a block 540.

At the block 535 the computer 16 slows the vehicle 12, e.g., by sending an instruction to the propulsion 30 and/or brake system 32. After the block 535 the process returns to the block 525.

At the block 540 the computer 16 actuates an output device to provide an indication that the seat-change request has been denied, e.g., by instructing the light 38 to actuate to provide a red colored light, by instructing the user interface 20 to actuate to provide such indication via a visual display or audible signal, etc. After the block 540 the process 500 may end. Alternatively, after the block 540 the process 500 may return to the block 510 awaiting another seat-change request, with the process 500 ending when the vehicle 12 is powered off or otherwise placed in an inoperable state.

At the block 545 the computer 16 actuates an output device to provide an indication that the seat-change request has been granted, e.g., by instructing the light 38 to actuate to provide a green colored light, by instructing the user interface 20 to actuate to provide such indication via a visual display or audible signal, etc. After the block 545 the process 500 may end. Alternatively, after the block 545 the process 500 may return to the block 510 awaiting another seat-change request, with the process 500 ending when the vehicle 12 is powered off or otherwise placed in an inoperable state.

### CONCLUSION

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

The adjectives “first” and “second” are used throughout this document as identifiers and are not intended to signify importance or order.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of systems and/or processes herein are provided for the purpose of illustrating certain embodiments, and should in no way be construed so as to limit the disclosed subject matter.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

The article “a” modifying a noun should be understood as meaning one or more unless stated otherwise, or context requires otherwise. The phrase “based on” encompasses being partly or entirely based on.

What is claimed is:

1. A system, comprising a computer programmed to:
receive data describing one or more vehicle operations from one or more vehicle input device; and
actuate an output device upon determining, based on the received data, that a seat-change condition is met.

2. The system of claim 1, the computer further programmed to determine that the seat-change condition is met based on a route of the vehicle.

3. The system of claim 1, the computer further programmed to determine that the seat-change condition is met based on a determination that the seat-change condition is predicted to continue to be met for a threshold amount of time.

4. The system of claim 3, the computer further programmed to identify the threshold amount of time based on a first seat location and a second seat location.

5. The system of claim 1, the computer further programmed to determine that the seat-change condition is met based on a determination that a speed of the vehicle is below a threshold.

6. The system of claim 1, the computer further programmed to reduce a speed of the vehicle upon determining that the seat-change condition is predicted to be met for less than a threshold amount of time.

7. The system of claim 1, the computer further programmed to actuate a vehicle restraint system to an unlocked state upon the determining that the seat-change condition is met.

8. The system of claim 1, the computer further programmed to determine that the seat-change condition is met based on a determination that no other vehicles are within a threshold distance of the vehicle.

9. The system of claim 1, the computer further programmed to determine that the seat-change condition is met based on a determination that the vehicle is predicted to not accelerate above a threshold amount within a threshold time.

10. The system of claim 1, the computer further programmed to determine that the seat-change condition is met based on a location of the vehicle.

11. A method comprising:
receiving data describing one or more vehicle operations from one or more vehicle input device; and
actuating an output device upon determining, based on the received data, that a seat-change condition is met.

12. The method of claim 11, wherein determining that the seat-change condition is met is based on a route of the vehicle.

13. The method of claim 11, wherein determining that the seat-change condition is met includes a determination that the seat-change condition is predicted to continue to be met for a threshold amount of time.

14. The method of claim 13, wherein the threshold amount of time is based on a first seat location and a second seat location.

15. The method of claim 11, wherein determining that the seat-change condition is met includes a determination that a speed of the vehicle is below a threshold.

16. The method of claim 11, further comprising reducing a speed of the vehicle upon determining that the seat-change condition is predicted to be met for less than a threshold amount of time.

17. The method of claim 11, further comprising actuating a vehicle restraint system to an unlocked state upon the determining that the seat-change condition is met.

18. The method of claim 11, wherein determining that the seat-change condition is met includes a determination that no other vehicles are within a threshold distance of the vehicle.

19. The method of claim 11, wherein determining that the seat-change condition is met includes a determination that the vehicle is predicted to not accelerate above a threshold amount within a threshold time.

20. The method of claim 11, wherein determining that the seat-change condition is met is based on a location of the vehicle.
